(19) United States
(12) Patent Application Publication
(10) Pub. No.: US 2019/0355198 A1
(43) Pub. Date: Nov. 21, 2019

(54) AUTHENTICATION INFORMATION ISSUANCE APPARATUS, AUTHENTICATION INFORMATION ISSUANCE METHOD, AND DELIVERY SYSTEM

(71) Applicant: TOYOTA JIDOSHA KABUSHIKI KAISHA, Toyota-shi (JP)

(72) Inventors: Etsuko NAKAJIMA, Nagoya-shi (JP); Naoki UENOYAMA, Nisshin-shi (JP); Junya MASUI, Nagoya-shi (JP); Akira HOSHINO, Nagoya-shi (JP); Hideo HASEGAWA, Nagoya-shi (JP); Keiko NAKANO, Kawasaki-shi (JP)

(73) Assignee: TOYOTA JIDOSHA KABUSHIKI KAISHA, Toyota-shi (JP)

(21) Appl. No.: 16/406,581

(22) Filed: May 8, 2019

(30) Foreign Application Priority Data
May 21, 2018 (JP) 2018-097264

(51) Int. Cl. G07C 9/00; H04L 29/06; G06Q 50/28

(52) U.S. Cl. CPC G07C 9/00896; H04L 63/0876; G07C 2009/0092; G07C 9/00309; G06Q 50/28

(57) ABSTRACT

An authentication information issuance apparatus is configured to issue authentication information for unlocking a storage device to a first mobile terminal. The storage device is configured to be unlocked and locked based on the authentication information acquired from the first mobile terminal. The storage device is configured to store a package. The authentication information issuance apparatus includes: an acquisition unit configured to acquire package information in which information for identifying the package and information for identifying the storage device are associated with each other; and an authentication information issuance unit configured to issue the authentication information to the first mobile terminal based on a request from the first mobile terminal. The authentication information is information for unlocking the storage device associated with the package.

### INCORPORATION BY REFERENCE

The disclosure of Japanese Patent Application No. 2018-097264 filed on May 21, 2018 including the specification, drawings and abstract is incorporated herein by reference in its entirety.

### BACKGROUND

### 1. Technical Field

The disclosure relates generally to a system for delivering a package, and more specifically to an authentication information issuance apparatus, an authentication information issuance method, and a delivery system capable of changing a method of receiving a package depending on the situation.

### 2. Description of Related Art

There is a technology that allows a recipient to pick up a delivery item at a boot of a vehicle designated as a delivery destination (see, for example, Japanese Unexamined Patent Application Publication No. 2006-206225 (JP 2006-206225 A)). According to this technology, a recipient designates the recipient's vehicle as a delivery destination, so that it is no longer necessary to install, for example, a delivery locker for reception of delivery items and the recipient can receive the delivery item even when the recipient is not at home.

### SUMMARY

In the system described above, a delivery terminal transmits authentication information to a vehicle, and the vehicle determines whether unlocking of the vehicle is permitted. That is, the authentication information needs to be issued before delivery is started. However, in some situations in actual delivery, it becomes impossible for a recipient to receive a delivery item in an originally-scheduled method due to various reasons. For example, although a recipient is scheduled to receive a delivery item face-to-face, the recipient needs to go out due to an urgent business or the recipient cannot answer the door for a while. However, in the related art, when a storage device, such as a vehicle, is not scheduled to be used and thus authentication information is not issued in advance, authentication information for unlocking the storage device cannot be acquired.

The disclosure provides an authentication information issuance apparatus, an authentication information issuance method, and a delivery system capable of changing a method of receiving a package depending on the situation.

A first aspect of the disclosure relates to an authentication information issuance apparatus configured to issue authentication information for unlocking a storage device to a first mobile terminal. The storage device is configured to be unlocked and locked based on the authentication information acquired from the first mobile terminal. The storage device is configured to store a package. The authentication information issuance apparatus includes: an acquisition unit configured to acquire package information in which information for identifying the package and information for identifying the storage device are associated with each other; and an authentication information issuance unit configured to issue the authentication information to the first mobile terminal based on a request from the first mobile terminal. The authentication information is information for unlocking the storage device associated with the package.

The storage device is a device configured to store a package and configured to be unlocked and locked. The storage device may be, but is not limited to, a vehicle cabin or a boot of a vehicle. Although an example in which the disclosure is applied to a vehicle will be described below, the disclosure is also applicable to facilities and storage devices other than vehicles. Further, the storage device has a function of communicating with the first mobile terminal to acquire the authentication information and performing unlocking and locking based on the authentication information. In the authentication information issuance apparatus, the acquisition unit specifies a storage device associated with a package to be delivered, and the authentication information issuance unit issues authentication information for unlocking the storage device associated with the package, based on a request from the first mobile terminal. With this configuration, a delivery person can acquire the authentication information for accessing the storage device in which the package is to be stored, using the package information (e.g., slip number) as a key. That is, even after the delivery person makes a departure to deliver the package, it is possible to unlock the storage device under the control of the consignee as needed.

In the authentication information issuance apparatus according to the first aspect of the disclosure, the acquisition unit may be configured to further acquire availability information in which the information for identifying the package and information about availability of the storage device are associated with each other, and the authentication information issuance unit may be configured to issue the authentication information when the availability information acquired by the acquisition unit indicates that use of the storage device is permitted.

The availability information is information indicating whether use of the storage device is permitted. The availability information may be issued by the consignee in advance or may be issued by the consignee in response to a request.

In the authentication information issuance apparatus according to the first aspect, the acquisition unit may be configured to further acquire information about a second mobile terminal carried by a consignee of the package, and the acquisition unit may be configured to acquire the availability information from the consignee via the second mobile terminal when there is a request from the first mobile terminal.

For example, when there is a request from the first mobile terminal, a message may be transmitted to the second mobile terminal carried by the consignee to cause the consignee to input the availability information. With this configuration, when the consignee cannot answer the door, the consignee can permit the use of the storage device on the spot.

In the authentication information issuance apparatus according to the first aspect, the acquisition unit may be configured to acquire, from the first mobile terminal, a slip number of the package as the information for identifying the package, when the acquisition unit acquires a request from the first mobile terminal.

The slip number given to the package is used as a key, so that necessary authentication information can be acquired quickly.

A second aspect of the disclosure relates to an authentication information issuance method executed by an authentication information issuance apparatus configured to issue authentication information for unlocking a storage device to a first mobile terminal. The storage device is configured to perform unlocking and locking of the storage device based on the authentication information acquired from the first mobile terminal. The storage device is configured to store a package. The authentication information issuance method includes: acquiring package information in which information for identifying the package and information for identifying the storage device are associated with each other; and issuing the authentication information to the first mobile terminal based on a request from the first mobile terminal. The authentication information is information for unlocking the storage device associated with the package.

A third aspect of the disclosure relates to a delivery system including: a storage device configured to store a package; and an authentication information issuance apparatus. The storage device includes: a reception unit configured to receive, from a first mobile terminal, authentication information for unlocking a door of the storage device; and an unlocking unit configured to unlock the door based on the authentication information. The authentication information issuance apparatus includes: an acquisition unit configured to acquire package information in which information for identifying the package and information for identifying the storage device are associated with each other; and an authentication information issuance unit configured to issue the authentication information to the first mobile terminal based on a request from the first mobile terminal. The authentication information is information for unlocking the storage device associated with the package.

The disclosure may be implemented as an authentication information issuance apparatus or a delivery system including at least some of the foregoing components. The disclosure may be implemented as a method executed by the authentication information issuance apparatus or the delivery system. The foregoing processes or components may be combined with each other for implementation of the disclosure as long as technical contradiction does not arise.

According to the foregoing aspects of the disclosure, it is possible to provide an authentication information issuance apparatus, an authentication information issuance method, and a delivery system capable of changing a method of receiving a package depending on the situation.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a system configuration diagram of a delivery system according to a first embodiment;

FIG. 2 is a block diagram illustrating components included in the delivery system according to the first embodiment;

FIG. 3 is a sequence diagram illustrating a data flow in the first embodiment;

FIG. 4 is a sequence diagram illustrating a data flow in the first embodiment;

FIG. 5A is a table illustrating vehicle information in the first embodiment;

FIG. 5B is a table illustrating vehicle information in the first embodiment;

FIG. 5C is a table illustrating vehicle information in the first embodiment;

FIG. 6 is a flowchart indicating details of a process in step S12 in the first embodiment; and

FIG. 7 is a flowchart indicating details of a process in step S12 in a second embodiment.

### DETAILED DESCRIPTION OF EMBODIMENTS

### First Embodiment

System Overview

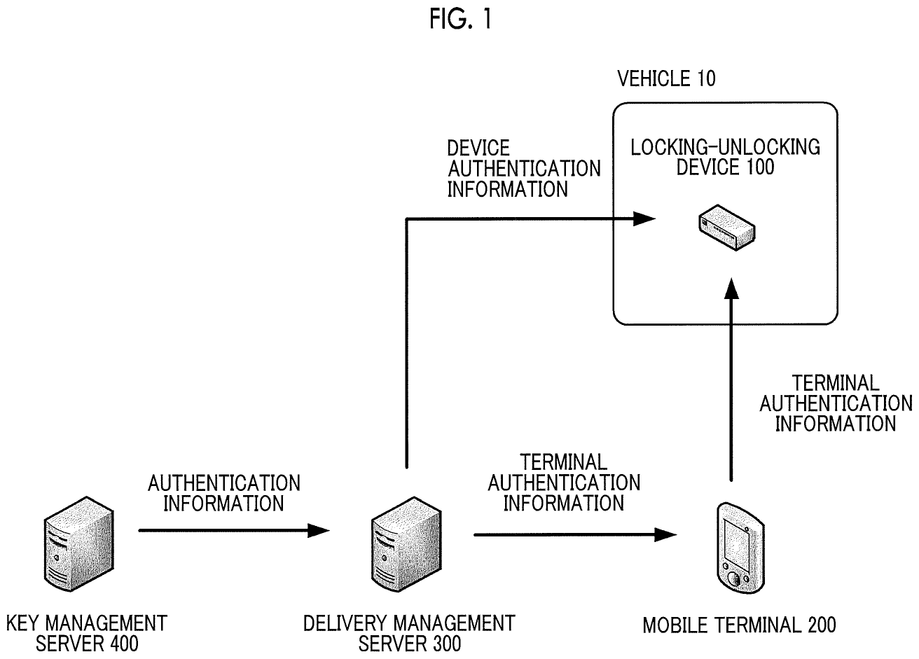

An overview of a delivery system according to a first embodiment will be described with reference to FIG. 1. The delivery system according to the first embodiment includes a locking-unlocking device 100, a mobile terminal 200, a delivery management server 300, and a key management server 400. In the delivery system according to the first embodiment, the locking-unlocking device 100 mounted in a vehicle 10 performs radio communication with the mobile terminal 200 present outside the vehicle 10, and unlocks and locks the vehicle 10 based on results of the communication. That is, a user of the delivery system can unlock and lock the vehicle 10 using only the mobile terminal 200 instead of using a hardware key. In the delivery system according to the first embodiment, a delivery person who delivers packages carries the mobile terminal 200, and can unlock and lock the vehicle 10 designated by a consignee, as needed. Thus, the vehicle 10 can be used as a delivery destination (delivery locker).

The key management server 400 is a server device that issues information (authentication information) based on which the locking-unlocking device 100 executes authentication of the mobile terminal 200. The key management server 400 issues first authentication information to the mobile terminal 200 via the delivery management server 300, and also issues second authentication information to the locking-unlocking device 100 via the delivery management server 300. The locking-unlocking device 100 checks the first authentication information and the second authentication information against each other to authenticate the mobile terminal 200.

The delivery management server 300 is a server device that manages delivery statuses of packages and mobile terminals 200 carried by a plurality of delivery persons who deliver the packages. Although FIG. 1 illustrates one mobile terminal 200 and one vehicle 10, the delivery management server 300 may manage a plurality of mobile terminals 200. Further, the mobile terminal 200 may be accessible to a plurality of vehicles 10.

System Configuration

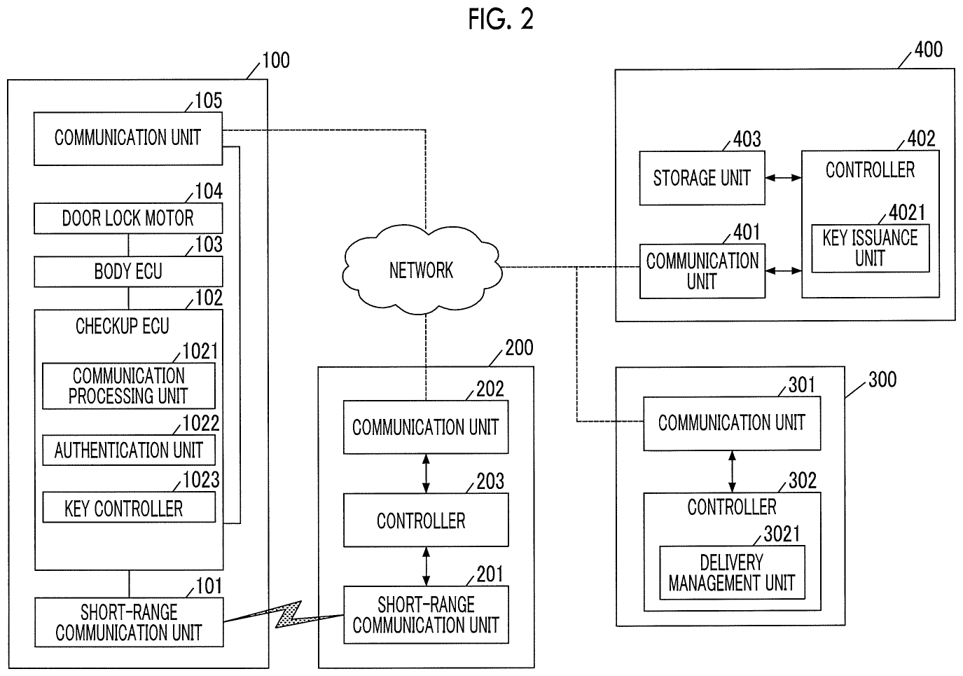

Components of the delivery system will be described in detail. FIG. 2 is a block diagram schematically illustrating an example of the configuration of each of the locking-unlocking device 100, the mobile terminal 200, the delivery management server 300, and the key management server 400 illustrated in FIG. 1. Among these components, the locking-unlocking device 100 is mounted in the vehicle 10 that is to be unlocked and locked.

The locking-unlocking device 100 is a device for unlocking and locking a door of the vehicle 10. More specifically, the locking-unlocking device 100 unlocks and locks the door of the vehicle 10 in response respectively to an unlocking signal and a locking signal that are transmitted, through radio waves in a high frequency band, from an electronic key (hereinafter, referred to as “portable device”) carried by a user of the vehicle 10. In the first embodiment, the locking-unlocking device 100 has a function of unlocking and locking the door based on results of the communication with the mobile terminal 200, in addition to the above-described function.

The locking-unlocking device 100 includes a short-range communication unit 101, a checkup electronic control unit (ECU) 102, a body ECU 103, a door lock motor 104, and a communication unit 105. The locking-unlocking device 100 operates with electric power supplied from an auxiliary battery mounted in the vehicle 10. In this example, illustration of a device for communicating with the electronic key is omitted.

The short-range communication unit 101 is a module that communicates with the mobile terminal 200 carried by the user. The short-range communication unit 101 performs communication within a short range (a range within which communication between the inside of a vehicle cabin and the outside thereof can be performed) under a predetermined radio communication standard.

In the first embodiment, the short-range communication unit 101 performs data communication under the Bluetooth (registered trademark) Low Energy standard (hereinafter, referred to as “BLE”). BLE is a low power communication standard using Bluetooth. BLE has such a characteristic that pairing between devices is not required and communication can be started upon detection of a communication partner. In the first embodiment, BLE is described as an example. However, other radio communication standards may be used. For example, Near-Field Communication (NFC), Ultra-Wideband (UWB), or WiFi (registered trademark) may be used.

The checkup ECU 102 is a computer that executes control of performing short-range radio communication with the mobile terminal 200 via the short-range communication unit 101 to authenticate the mobile terminal 200 and executes control for unlocking and locking the door of the vehicle 10 based on a result of the authentication. The checkup ECU 102 is, for example, a microcomputer. In the following description, a locking signal and an unlocking signal will be collectively referred to as “locking-unlocking signal”. The term “locking-unlocking signal” indicates at least one of a locking signal and an unlocking signal.

The checkup ECU 102 includes a communication processing unit 1021, an authentication unit 1022, and a key controller 1023, as functional modules. Each functional module may be implemented when a central processing unit (CPU) executes a program stored in a storage device, such as a read-only memory (ROM).

The communication processing unit 1021 processes communication with the mobile terminal 200 that is performed via the short-range communication unit 101. Specifically, the communication processing unit 1021 receives a locking request or an unlocking request (hereinafter, collectively referred to as “locking-unlocking request”) from the mobile terminal 200, and generates a locking-unlocking signal in response to the received request. The generated locking-unlocking signal is temporarily stored and is output at a timing at which the authentication unit 1022 successfully authenticates the mobile terminal 200.

The authentication unit 1022 executes authentication of the mobile terminal 200 based on the authentication information included in the locking-unlocking request transmitted from the mobile terminal 200. Specifically, the authentication unit 1022 compares the authentication information stored in the storage device with the authentication information transmitted from the mobile terminal 200. When the authentication information transmitted from the mobile terminal 200 matches the authentication information stored in the storage device, the authentication unit 1022 determines that the authentication is successful. On the other hand, the authentication information transmitted from the mobile terminal 200 does not match the authentication information stored in the storage device, the authentication unit 1022 determines that the authentication is unsuccessful. When the authentication unit 1022 successfully authenticates the mobile terminal 200, the locking-unlocking signal generated by the communication processing unit 1021 is transmitted to the key controller 1023 (described later). A method of authentication executed by the authentication unit 1022 may be a method of simply comparing the authentication information stored in the storage device with the authentication information transmitted from the mobile terminal 200 to verify whether they match each other, or may be a method in which asymmetric ciphers are used. The term “match” described above means not only that the two pieces of authentication information are identical with each other but also that the two pieces of information can be confirmed to correspond to each other. Hereinafter, the authentication information stored in the locking-unlocking device 100 will be referred to as “device authentication information”, and the authentication information transmitted from the mobile terminal 200 will be referred to as “terminal authentication information”, as needed. When it is not necessary to distinguish the authentication information stored in the locking-unlocking device 100 and the authentication information transmitted from the mobile terminal 200 from each other, they will be simply referred to as “authentication information”. The device authentication information is generated by the key management server 400 (described later) and received via the network and stored in the authentication unit 1022.

The key controller 1023 transmits an unlocking command or a locking command to the body ECU 103 (described below), based on the result of authentication executed by the authentication unit 1022. The unlocking command or locking command is transmitted via an in-vehicle network, such as Controller Area Network (CAN).

The body ECU 103 is a computer that controls a body of the vehicle 10. The body ECU 103 has a function of unlocking and locking the door of the vehicle 10 by controlling the door lock motor 104 (described below) based on the received unlocking command or locking command. The body ECU 103 may further have a function of executing controls of components related to the vehicle body, such as power window control, seat adjustment control, anti-theft control, seatbelt control, and headlight control.

The door lock motor 104 is an actuator for unlocking and locking doors (including a boot door in addition to doors for occupants and a rear gate door) of the vehicle 10. The door lock motor 104 operates based on a signal transmitted from the body ECU 103.

The communication unit 105 is a communication interface for connecting the locking-unlocking device 100 to the network. In the first embodiment, the communication unit 105 can communicate with another device via the network using a mobile communication service, such as 3rd Generation (3G) or Long Term Evolution (LTE).

Next, the mobile terminal 200 will be described. The mobile terminal 200 is a small computer, such as a smartphone, a mobile phone, a tablet computer, a personal digital assistant, a laptop computer, or a wearable computer (e.g., a smart watch). The mobile terminal 200 includes a short-range communication unit 201, a communication unit 202, and a controller 203.

The short-range communication unit 201 is configured to communicate with the locking-unlocking device 100 under the same communication standard as that for the short-range communication unit 101. Like the communication unit 105, the communication unit 202 is a communication interface for establishing a network connection.

The controller 203 is configured to control the mobile terminal 200. The controller 203 executes, for example, a process of generating a locking-unlocking request, a process of acquiring the terminal authentication information described above, and a process of transmitting the locking-unlocking request and the terminal authentication information to the locking-unlocking device 100. The controller 203 is, for example, a microcomputer. The controller 203 may implement these processes when a CPU executes programs stored in a storage device, such as a ROM.

The controller 203 is connected to an input-output unit that interacts with the user. The input-output unit includes, for example, a touch panel, a control unit for the touch panel, a liquid crystal display, and a control unit for the liquid crystal display. In the first embodiment, the touch panel and the liquid crystal display are integrated into a single-piece touch panel display.

The controller 203 causes the input-output unit to display a manipulation screen, and generates an unlocking request or a locking request based on a manipulation performed by the user. For example, the controller 203 outputs an icon for unlocking and an icon for locking to the touch panel display. Then, the controller 203 generates an unlocking request or a locking request based on a manipulation performed by the user. The manipulation performed by the user is not limited to a manipulation performed using the touch panel display. The manipulation may be, for example, a manipulation performed using a hardware switch or the like.

Further, the controller 203 executes a process of acquiring terminal authentication information. In the first embodiment, the terminal authentication information is generated by the key management server 400 (described later), and transferred to the mobile terminal 200 via the delivery management server 300 (described later). The combination of the key management server 400 and the delivery management server 300 is an example of “the authentication information issuance apparatus” of the disclosure. When the mobile terminal 200 does not have the terminal authentication information, it is not possible to perform the locking manipulation or the unlocking manipulation on the manipulation screen.

The terminal authentication information acquired by the mobile terminal 200 may be an invariant key or a one-time key. In either case, the device authentication information corresponding to the terminal authentication information is stored in the locking-unlocking device 100 in advance.

Next, the delivery management server 300 will be described. The delivery management server 300 is a server device that manages packages to be delivered and the mobile terminals 200 carried by a plurality of delivery persons. The delivery management server 300 stores information about the packages to be delivered. When the vehicle 10 is designated as a delivery destination of a package, the delivery management server 300 acquires the terminal authentication information for unlocking and locking the vehicle 10 where the package is to be stored, from the key management server 400, and transfers the terminal authentication information to the mobile terminal 200. This process is executed before the delivery person makes a departure to deliver the package.

Further, the delivery management server 300 acquires the device authentication information to be stored in the locking-unlocking device 100 of the vehicle 10 from the key management server 400, and transfers the device authentication information to the locking-unlocking device 100 (the checkup ECU 102). This process may be executed each time package delivery is requested or may be executed at a timing that is independent of the package delivery. In the first embodiment, the device authentication information is acquired at the time of system setup and transferred to the locking-unlocking device 100.

The delivery management server 300 includes a communication unit 301 and a controller 302. Like the communication unit 105, the communication unit 301 is a communication interface for establishing a network connection. The controller 302 is configured to control the delivery management server 300. The controller 302 is, for example, a CPU. The controller 302 includes a delivery management unit 3021 as a functional module. The functional module may be implemented when the CPU executes a program stored in a storage device, such as a ROM.

The delivery management unit 3021 is configured to store and manage, for example, the information about a user who is a consignee, the information about the vehicle 10 which is under the control of the user and is used as a delivery destination, and the information about the package associated with the user. When the delivery management unit 3021 receives, from the mobile terminal 200, the information about a package to be delivered, the delivery management unit 3021 specifies the vehicle 10 to be used as a delivery destination and requests the key management server 400 to issue the terminal authentication information for unlocking and locking the vehicle 10. The delivery management unit 3021 transfers the terminal authentication information issued by the key management server 400 to the mobile terminal 200. In the first embodiment, the device authentication information may be issued at either a timing before the delivery person makes a departure to deliver the package or a timing after the departure. A detailed process will be described later.

Next, the key management server 400 will be described. The key management server 400 is a device that issues, in response to a request from the delivery management server 300, terminal authentication information for the mobile terminal 200 and device authentication information for the locking-unlocking device 100. The key management server 400 includes a communication unit 401, a controller 402, and a storage unit 403.

Like the communication unit 301, the communication unit 401 is a communication interface for establishing a network connection.

The controller 402 is configured to control the key management server 400. The controller 402 is, for example, a CPU. The controller 402 includes a key issuance unit 4021 as a functional module. The functional module may be implemented when the CPU executes a program stored in a storage device, such as a ROM.

The key issuance unit 4021 issues terminal authentication information and device authentication information, in response to a request from the delivery management server 300. As described above, the terminal authentication information is authentication information based on which the mobile terminal 200 unlocks and locks the vehicle 10 via the locking-unlocking device 100. The device authentication information is authentication information that pairs up with the terminal authentication information.

The terminal authentication information and the device authentication information stored in advance may be acquired or the terminal authentication information and the device authentication information may be generated. For example, authentication information that is valid only within a predetermined time period, authentication information of which the number of uses is designated, or authentication information that can be used only in a predetermined mobile terminal 200 may be generated. When the vehicle 10 includes a plurality of compartments that can be unlocked and locked independently from each other, such as a vehicle cabin and a boot, authentication information for unlocking and locking only one of the compartments may be generated.

The storage unit 403 is configured to store information, and is a storage medium, such as a random-access memory (RAM), a magnetic disk, or a flash memory. The storage unit 403 stores device authentication information to be stored in the locking-unlocking device 100, terminal authentication information that pairs up with the device authentication information, and various kinds of data for generating the device authentication information and the terminal authentication information.

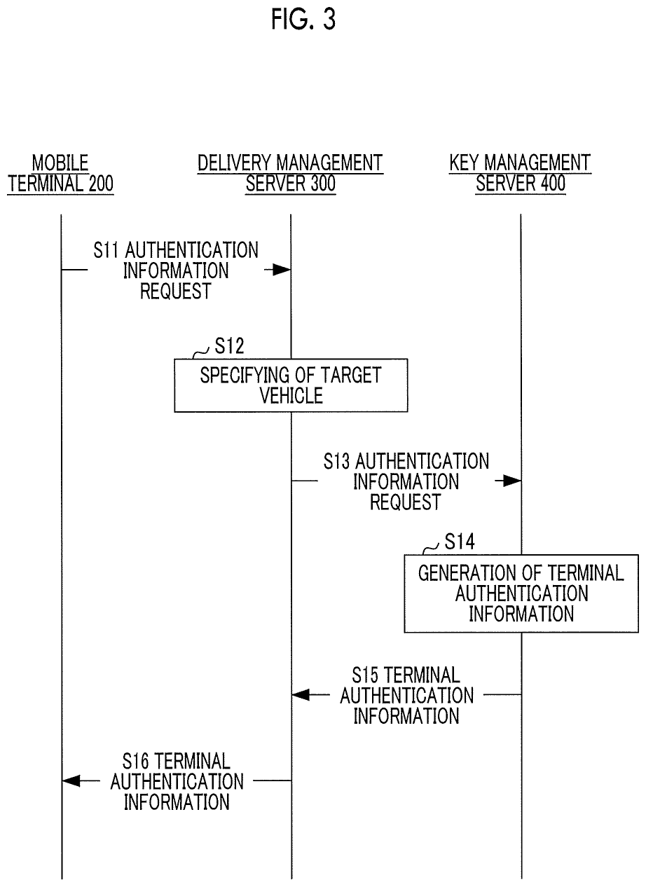

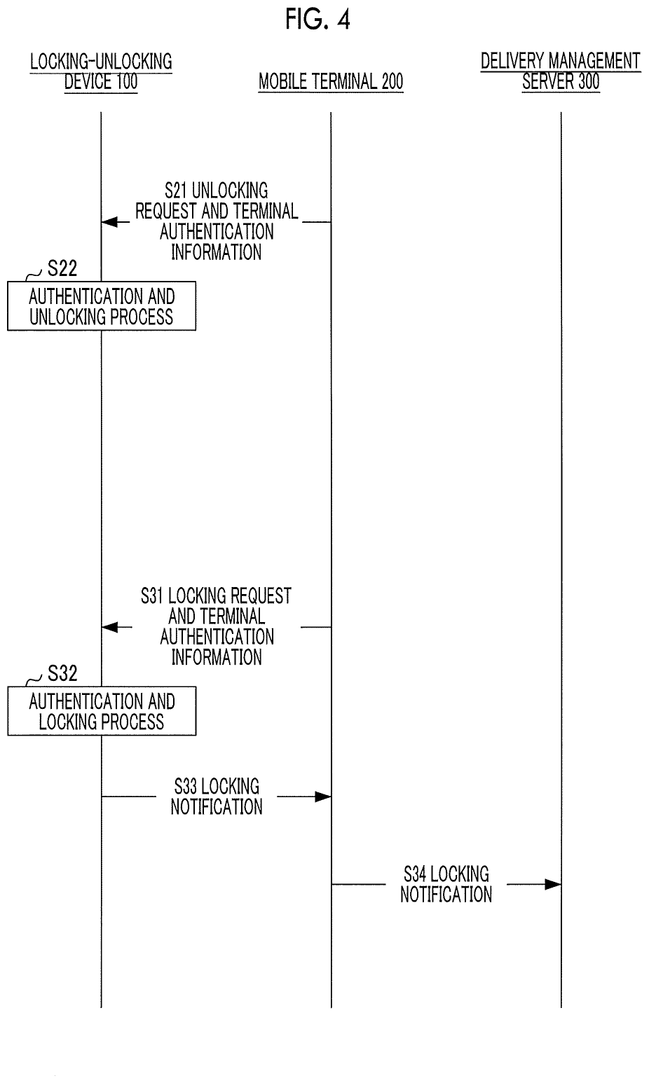

Next, a process that is executed by the foregoing components will be described. The process is divided into a first phase and a second phase. In the first phase, the mobile terminal 200 acquires terminal authentication information. In the second phase, the mobile terminal 200 accesses the locking-unlocking device 100 using the acquired terminal authentication information, and unlocks and locks the vehicle 10. FIG. 3 is a sequence diagram illustrating a data flow in the first phase. FIG. 4 is a sequence diagram illustrating a data flow in the second phase.

The first phase will be described with reference to FIG. 3. Processes in steps S11 to S16 are executed when the mobile terminal 200 makes a request for issuance of terminal authentication information. First, in step S11, the mobile terminal 200 requests the delivery management server 300 to issue the terminal authentication information. In step S11, information for identifying the mobile terminal 200 and information for uniquely identifying a package to be delivered (hereinafter, referred to as a “package ID”. The package ID may be, for example, a slip number, or a combination of a slip number and a user identifier) are simultaneously transmitted as a request for authentication information (hereinafter, referred to as “authentication information request”).

In step S12, the delivery management server 300 (the delivery management unit 3021) specifies the vehicle 10 to be used as a delivery destination. In the first embodiment, the delivery management unit 3021 stores, in advance, information about the package and information about the vehicle 10 to be used as the delivery destination of the package (hereinafter, referred to as “vehicle information”), and specifies the vehicle 10 to be used as the delivery destination based on these pieces of information. The vehicle information may be set by a consignee each time package delivery is requested or may be automatically generated by the delivery management unit 3021 under authority granted by the consignee.

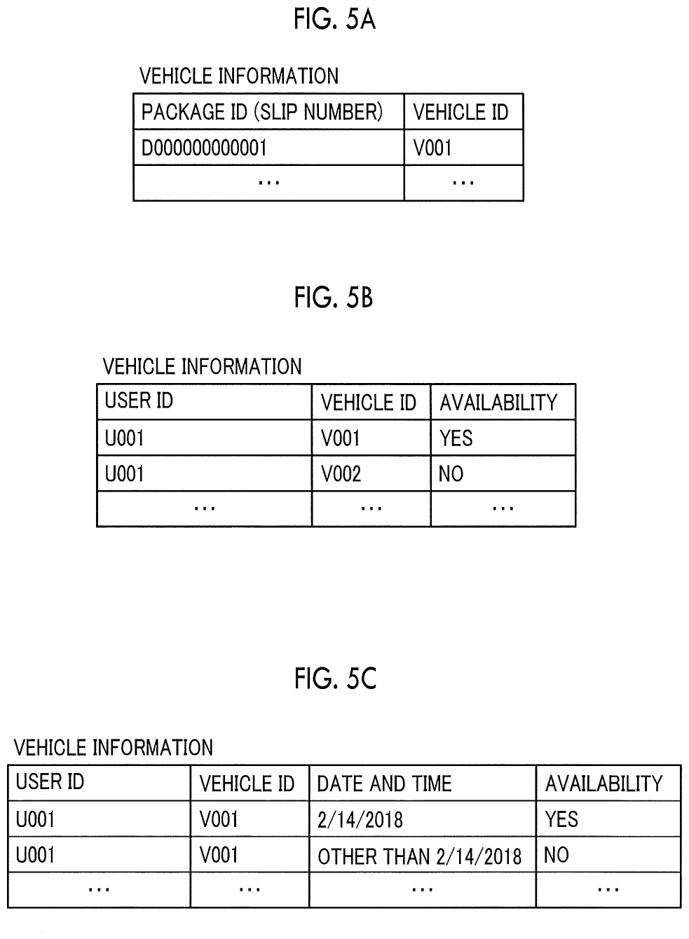

FIG. 5A to FIG. 5C are examples of the vehicle information. As illustrated in FIG. 5A, the vehicle information may be information in which only a package ID (a slip number in this example) and an identifier of the vehicle 10 (hereinafter, referred to as “vehicle ID”) are associated with each other. The example in FIG. 5A indicates that the package is permitted to be delivered to the vehicle 10 when the package ID and the vehicle ID are associated with each other.

Alternatively, as illustrated in FIG. 5B, the vehicle information may be information in which an identifier of a user (hereinafter, referred to as “user ID”), instead of the package ID, and the vehicle ID are associated with each other. When the user ID and the package ID are associated with each other, such information can be regarded as information in which the package ID and the vehicle ID are associated with each other. The vehicle information may be information in which the user ID, the vehicle ID, and availability of the vehicle 10 are associated with each other. Further alternatively, as illustrated in FIG. 5C, the vehicle information may be information in which the user ID, the vehicle ID, and date and time when the vehicle 10 is available are associated with each other. After conditions are specified in detail as described above, availability of the vehicle 10 may be set for each of the conditions. Among these pieces of vehicle information, a piece of information in which the package ID is associated with the vehicle ID is an example of “package information”, and a piece of information indicating availability of the vehicle 10 is an example of “availability information”.

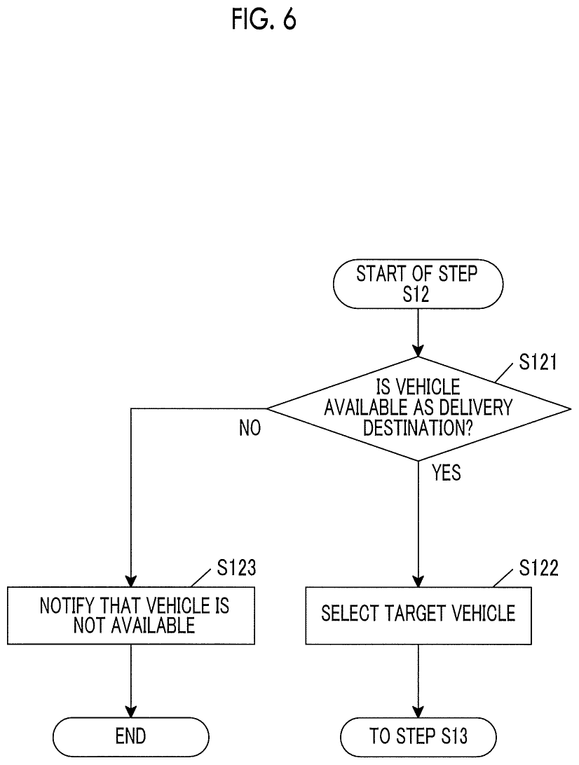

FIG. 6 is a flowchart indicating the process in step S12 in more detail. First, in step S121, the delivery management unit 3021 determines whether the vehicle 10 is available as a delivery destination of the package based on the package ID included in the authentication information request and the vehicle information stored in advance. When it is determined that the vehicle 10 is available, a corresponding vehicle 10 is selected (step S122), and the process proceeds to step S13. In step S13, the delivery management unit 3021 adds the vehicle ID to the authentication information request and transmits the authentication information request to the key management server 400.

On the other hand, when the vehicle 10 is not available as a delivery destination of the package (when the use of the vehicle 10 is not permitted or when there is no information about the vehicle 10), the delivery management unit 3021 generates a notification indicating that the vehicle 10 is not available as a delivery destination, and transmits the notification to the mobile terminal 200 (step S123). In this case, the process illustrated in FIG. 3 ends. When two or more vehicles 10 are available as a delivery destination of the package, any one of the vehicles 10 can be selected and the process can proceed. Selection of a vehicle 10 may be made by a delivery person or may be made automatically by a device. Alternatively, the delivery management unit 3021 may select a vehicle 10 with reference to the information about the package. For example, a vehicle 10 with a compartment having a size corresponding to the size of the package may be automatically selected.

In step S14, the key issuance unit 4021 generates or acquires terminal authentication information unique to the mobile terminal 200 and the vehicle 10 (the locking-unlocking device 100 mounted in the vehicle 10).

Then, in step S15, the generated terminal authentication information is transmitted to the delivery management server 300 (step S15). Then, the delivery management server 300 transfers the terminal authentication information to the mobile terminal 200 (step S16). Thus, a manipulation for unlocking the vehicle 10 can be performed on the mobile terminal 200. In steps S15 and S16, it is desirable to transmit information for identifying the vehicle 10 to be used as the delivery destination, as information that accompanies the terminal authentication information. Transmitting, for example, information about a vehicle type or a license plate, or information about the position of the vehicle 10 along with the terminal authentication information makes it easier for the delivery person to find a vehicle 10 to be used as a delivery destination.

Although the terminal authentication information is transferred via the delivery management server 300 in this example, the terminal authentication information may be directly transmitted from the key management server 400 to the mobile terminal 200. The device authentication information is issued by the key management server 400 and stored in the locking-unlocking device 100 in advance in this example. Alternatively, the key management server 400 may issue the device authentication information at the same timing as execution of the process in FIG. 3 and transfer the device authentication information to the locking-unlocking device 100 via the delivery management server 300.

The processes in steps S11 to S16 are processes of preparation for unlocking and locking of the vehicle 10. Thus, it is desirable to execute these processes in advance. For example, these processes may be executed at a delivery preparation stage.

The second phase will be described with reference to FIG. 4. Steps S21 to S22 are processes for unlocking the vehicle 10 using the mobile terminal 200. A user (that is, a delivery person) of the mobile terminal 200 performs a manipulation for unlocking the vehicle 10 using the input-output unit. As a result, under BLE, a link is established between the mobile terminal 200 and the locking-unlocking device 100. Thus, in step S21, the mobile terminal 200 transmits an unlocking request and the terminal authentication information to the locking-unlocking device 100.

In step S22, the authentication unit 1022 of the locking-unlocking device 100 checks the terminal authentication information transmitted from the mobile terminal 200 against the device authentication information stored in advance, to execute an authentication process. When the authentication is successful, the key controller 1023 unlocks the door of the vehicle 10.

Steps S31 to S34 are processes of locking the vehicle 10 using the mobile terminal 200. When the user of the mobile terminal 200 performs a manipulation for locking the vehicle 10 using the input-output unit (e.g., a touch panel screen), the mobile terminal 200 transmits a locking request and the terminal authentication information to the locking-unlocking device 100 in step S31.

In step S32, the authentication unit 1022 of the locking-unlocking device 100 checks the terminal authentication information transmitted from the mobile terminal 200 against the device authentication information stored in advance, to execute an authentication process. When the authentication is successful, the key controller 1023 locks the door of the vehicle 10.

After the door of the vehicle 10 is locked, the communication processing unit 1031 of the locking-unlocking device 100 transmits a notification (locking notification) indicating that locking of the vehicle 10 has been completed to the mobile terminal 200 (step S33). Thus, the notification indicating that locking of the vehicle 10 has been completed is output on the touch panel screen of the mobile terminal 200. When the terminal authentication information is a one-time key, the one-time key may be invalidated at the timing of step S33. Finally, the mobile terminal 200 transmits the locking notification to the delivery management server 300 (step S34). The delivery management server 300 may transmit a message indicating that delivery has been completed to a terminal associated with the consignee (e.g., a mobile terminal carried by the consignee).

The operation described above is an operation to be executed when the vehicle 10 is designated as a delivery destination of the package in advance. However, in some situations, although the consignee is scheduled to receive the package face-to-face, it becomes impossible for the consignee to receive the package in an originally-scheduled method due to various reasons. These situations include a situation where the consignee needs to go out due to an urgent business although the consignee is scheduled to receive the package face-to-face or a situation where the consignee cannot answer the door for a while although the consignee is scheduled to receive the package face-to-face.

In order to deal with these situations, the delivery management server 300 according to the first embodiment is configured to be able to receive the authentication information request from the mobile terminal 200 even after delivery is started. For example, it is assumed that the consignee cannot answer the door when the delivery person visits the consignee. In this case, the delivery person transmits an authentication information request including the package ID to the delivery management server 300, using the mobile terminal 200. The delivery management server 300 executes a search to determine whether there is a vehicle 10 to which the package can be delivered (a vehicle 10 to which the package is permitted to be delivered). When there is such a vehicle 10, the delivery management server 300 transmits terminal authentication information corresponding to the vehicle 10 to the mobile terminal 200. Thus, the delivery person can change a delivery method from a method of delivering the package to the consignee face-to-face to a method of delivering the package to the consignee via the vehicle 10.

In the first embodiment, whether receipt of the package via the vehicle 10 is permitted is indicated by the vehicle information stored in the delivery management server 300. The vehicle information may be further provided with a sign for determining whether the permission is an active permission (the consignee desires delivery of the package to the vehicle 10) or a passive permission (the consignee desires delivery of the package to the vehicle 10 only when the consignee cannot receive the package face-to-face). When the permission is a passive permission, further restrictions may be imposed on issuance of the authentication information. For example, issuance of the authentication information can be requested only at a designated place or only at designated date and time.

### Second Embodiment

In the first embodiment, the consignee needs to determine whether to permit receipt of a package via the vehicle 10 and the result of determination needs to be stored in advance in the delivery management server 300 as vehicle information. In contrast to this, in a second embodiment, an inquiry about whether to permit receipt of a package via the vehicle 10 is made to the consignee each time.

In the second embodiment, the delivery management server 300 stores information in which a package to be delivered and a terminal associated with the consignee of the package (e.g., a mobile terminal carried by the consignee) are associated with each other.

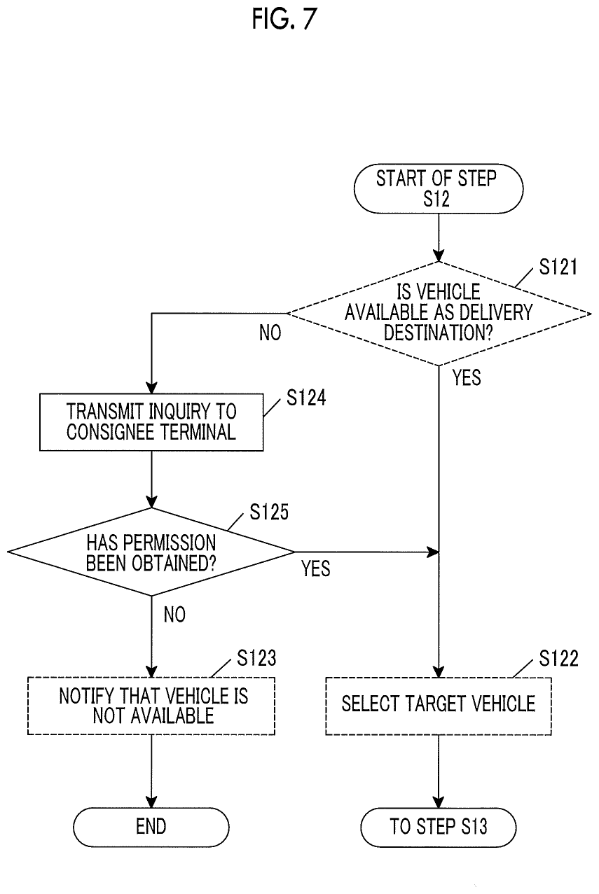

FIG. 7 is a flowchart illustrating the details of a process in step S12 in the second embodiment. In the second embodiment, in step S121, in a case where there is no vehicle 10 that is available as a delivery destination (including a case where the vehicle information is not stored in the delivery management server 300), an inquiry about whether the consignee permits delivery of the package to the vehicle 10 is transmitted to the terminal associated with the consignee (the consignee's terminal) (step S124).

In step S124, when there is information about the vehicle 10 that is under the control of the consignee, the consignee is asked to select whether to permit delivery of the package to the vehicle 10. When there is no information about the vehicle 10 that is under the control of the consignee, the consignee is asked to input the vehicle ID of the vehicle 10. When there is a plurality of vehicles 10 under the control of the consignee, the consignee may be asked to select one of the vehicles 10.

When the consignee performs a manipulation for permitting delivery of the package to the vehicle 10 (Yes in step S125), the process proceeds to step S122, and the vehicle 10 to be used as a delivery destination is selected. On the other hand, in a case where a permission is not granted by the consignee (including a case where no response is issued within a predetermined time), the process proceeds to step S123 and a notification indicating that the vehicle 10 is not available as a delivery destination is transmitted to the mobile terminal 200.

As described above, according to the second embodiment, the vehicle 10 can be designated as a delivery destination of the package even when whether to permit delivery to the vehicle 10 is not set in advance.

### Modification Example

Each of the foregoing embodiments is just an example embodiment, and various kinds of modifications may be made to the foregoing embodiments within the technical scope of the disclosure.

For example, in the foregoing embodiments, a vehicle cabin or a boot of a vehicle is illustrated as a compartment that can store a package and that can be unlocked and locked. However, such a compartment is not limited to a vehicle cabin or a boot of a vehicle. The disclosure may be applicable not only to vehicles but also to facilities or storage devices, as long as the facilities or the storage devices have a compartment that can be unlocked and locked using a mobile terminal.

What is claimed is:

1. An authentication information issuance apparatus configured to issue authentication information for unlocking a storage device to a first mobile terminal, the storage device being configured to be unlocked and locked based on the authentication information acquired from the first mobile terminal, and the storage device being configured to store a package, the authentication information issuance apparatus comprising:
an acquisition unit configured to acquire package information in which information for identifying the package and information for identifying the storage device are associated with each other; and
an authentication information issuance unit configured to issue the authentication information to the first mobile terminal based on a request from the first mobile terminal, the authentication information being information for unlocking the storage device associated with the package.

2. The authentication information issuance apparatus according to claim 1, wherein:
the acquisition unit is configured to further acquire availability information in which the information for identifying the package and information about availability of the storage device are associated with each other; and
the authentication information issuance unit is configured to issue the authentication information when the availability information acquired by the acquisition unit indicates that use of the storage device is permitted.

3. The authentication information issuance apparatus according to claim 2, wherein:
the acquisition unit is configured to further acquire information about a second mobile terminal carried by a consignee of the package; and
the acquisition unit is configured to acquire the availability information from the consignee via the second mobile terminal when there is a request from the first mobile terminal.

4. The authentication information issuance apparatus according to claim 1, wherein the acquisition unit is configured to acquire, from the first mobile terminal, a slip number of the package as the information for identifying the package, when the acquisition unit acquires a request from the first mobile terminal.

5. An authentication information issuance method executed by an authentication information issuance apparatus configured to issue authentication information for unlocking a storage device to a first mobile terminal, the storage device being configured to be unlocked and locked based on the authentication information acquired from the first mobile terminal, and the storage device being configured to store a package, the authentication information issuance method comprising:
acquiring package information in which information for identifying the package and information for identifying the storage device are associated with each other; and
issuing the authentication information to the first mobile terminal based on a request from the first mobile terminal, the authentication information being information for unlocking the storage device associated with the package.

6. A delivery system comprising:
a storage device configured to store a package; and
an authentication information issuance apparatus, wherein
the storage device includes
a reception unit configured to receive, from a first mobile terminal, authentication information for unlocking a door of the storage device, and
an unlocking unit configured to unlock the door based on the authentication information, and
the authentication information issuance apparatus includes
an acquisition unit configured to acquire package information in which information for identifying the package and information for identifying the storage device are associated with each other, and
an authentication information issuance unit configured to issue the authentication information to the first mobile terminal based on a request from the first mobile terminal, the authentication information being information for unlocking the storage device associated with the package.
